(19) United States
(12) Patent Application Publication
(10) Pub. No.: US 2003/0052574 A1
(43) Pub. Date: Mar. 20, 2003

(54) Ultrasonic motor and method for manufacturing the same

(76) Inventors: Yukihiro Matsushita, Hamakita-shi (JP); Motoyasu Yano, Kosai-shi (JP); Masashi Ishikawa, Hamamatsu-shi (JP)

Correspondence Address: D. PETER HOCHBERG CO. L.P.A., 1940 EAST 6TH STREET, CLEVELAND, OH, 44114, US

(21) Appl. No.: 10/235,964

(22) Filed: Sep. 4, 2002

(30) Foreign Application Priority Data
Sep. 7, 2001 (JP) 2001-271862

(51) Int. Cl. H02N 2/12

(52) U.S. Cl. 310/323.02

(57) ABSTRACT

An ultrasonic motor comprises a stator, a rotor and a fixing portion. The stator has a first block, a second block and a piezoelectric element, which is held between the first and second blocks. The piezoelectric element vibrates when receiving a drive voltage having a predetermined frequency, and the stator produces resonance vibration in accordance with vibration of the piezoelectric element. The rotor is pressed on the stator in a slidable manner and rotates due to the vibration of the stator. The fixing portion is provided on the stator to fix the stator to a predetermined support portion. The fixing portion is formed in such a way that a natural frequency of the fixing portion comes off a frequency range of the drive voltage where the rotor is rotatable. This structure provides an ultrasonic motor which is quiet and has high energy conversion efficiency.

### BACKGROUND OF THE INVENTION

The present invention relates to an ultrasonic motor.

As shown in FIG. 16, a typical standing-wave type (bolted Langevin type) ultrasonic motor 41 has a stator 42 and a rotor 43. The stator 42 includes first and second blocks 44 and 45, first and second piezoelectric elements 46 and 47, first and second electrodes 48 and 49 and an unillustrated bolt. Both blocks 44 and 45, both piezoelectric elements 46 and 47, and both electrodes 48 and 49 are laminated in an substantially cylindrical shape as shown in FIG. 16. As both blocks 44 and 45 are fastened by the bolt that penetrates through the blocks 44 and 45 in the axial direction, both blocks 44 and 45, both piezoelectric elements 46 and 47 and both electrodes 48 and 49 are coupled together.

When a high-frequency voltage is applied to both electrodes 48 and 49, both piezoelectric elements 46 and 47 generate a longitudinal vibration. Due to the longitudinal vibration, a longitudinal vibration is generated on the top surface of the stator 42 and is transmitted to the rotor 43. The longitudinal vibration transmitted to the rotor 43 generates a torsional vibration all over the rotor 43. The torsional vibration of the rotor 43 causes the rotor 43 to rotate in a predetermined direction.

A plurality of first slits 43a are formed on the outer surface of the rotor 43 formed in an substantially cylindrical shape. The rotor 43 is pressed in contact with the top surface of the stator 42, or a top surface 44a of the first block 44, in a rotatable manner by an unillustrated pressing mechanism. At least one second slit 45a is formed in the lower portion of the stator 42 or in the second block 45. The first slits 43a and second slit 45a promote the torsional vibration that is generated all over the rotor 43, thereby increasing the amplitude of the torsional vibration. This allows the rotor 43 to rotate efficiently.

FIG. 17 illustrates the relationship between the frequency f of the high-frequency voltage and a vibration speed v of the stator 42 (the top surface 44a of the first block 44). In FIG. 17, a radial vibration speed vr of the top surface 44a of the first block 44 is indicated by the solid line, a torsional vibration speed vθ is indicated by the two-dot chain line, and a longitudinal vibration speed vz is indicated by the broken line.

When the frequency f of the high-frequency voltage is in the vicinity of a first frequency f1 (near about 60 KHz), the values of the torsional vibration speed vθ and the longitudinal vibration speed vz increase. Near the first frequency f1, the rotor 43 rotates in a predetermined direction by the buoyancy originated from the longitudinal vibration component of the stator 42 and the propulsive force originated from the torsional vibration component of the stator 42. FIG. 18 shows the shape of the stator 42 at that time which is specified by using the FEM (Finite Element Method).

As shown in FIG. 16, the second block 45 has a flange 51 for holding the stator 42. The flange 51 is coupled to an unillustrated housing by a keyway, a screw, crimping or the like.

FIG. 19 shows the relationship between the frequency f of the high-frequency voltage and the vibration speed v of the flange 51 when the high-frequency voltage is applied to the ultrasonic motor 41 having the flange 51. As shown in FIG. 19, when the frequency f of the high-frequency voltage is in the vicinity of a second frequency f2, the values of the radial vibration speed vr of the flange 51, the torsional vibration speed vθ and the longitudinal vibration speed vz become large. The shape of the flange at the second frequency f2, when specified by using the FEM, is shown in FIG. 20. Apparently, a large vibration is generated on the flange 51.

The second frequency f2 that generates a large vibration on the flange 51 is substantially equal to the first frequency f1 (see FIG. 17) at the time the rotor 43 rotates. This is because the optimal frequency range of the high-frequency voltage to drive the ultrasonic motor 41 coincides with the natural frequency of the flange 51.

At the time the ultrasonic motor 41 is driven, therefore, a large vibration is generated on the flange 51, thus causing problems, such as reduction in the rotational efficiency of the rotor 43 and generation of an abnormal sound.

The first frequency f1 at the time the rotor 43 rotates may overlap the resonance frequency associated with the radial stretching vibration of both piezoelectric elements 46 and 47, so that when the stator 42 vibrates at the first frequency f1, both piezoelectric elements 46 and 47 may resonate in the radial direction. The resonance causes a vibration loss of the stator 42, which drops the rotational efficiency of the rotor 43.

If the difference between the first frequency f1 and the resonance frequency of both piezoelectric elements 46 and 47 is slight, beating occurs. This generates an abnormal sound in the ultrasonic motor 41.

### SUMMARY OF THE INVENTION

Accordingly, it is an objective of the present invention to provide a ultrasonic motor which is quiet and has a high energy conversion efficiency.

To achieve the above object, the present invention provides an ultrasonic motor described below. The ultrasonic motor comprises a stator, a rotor and a fixing portion. The stator has a first block, a second block and a piezoelectric element, which is held between the first and second blocks. The piezoelectric element vibrates when receiving a drive voltage having a predetermined frequency, and the stator produces a resonance vibration in accordance with the vibration of the piezoelectric element. The rotor is pressed on the stator in a slidable manner and rotates due to the vibration of the stator. The fixing portion is provided on the stator to fix the stator to a predetermined support portion. The fixing portion is formed in such a way that a natural frequency of the fixing portion deviates from the frequency range of a drive voltage where the rotor is rotatable.

The present invention further provides an ultrasonic motor described below. The ultrasonic motor comprises a stator having a piezoelectric element and a rotor that is pressed on the stator in a slidable manner and rotates due to the vibration of the stator. The piezoelectric element vibrates when receiving a drive voltage having a predetermined frequency. The stator produces a resonance vibration in accordance with the vibration of the piezoelectric element. The stator is formed in such a way that a frequency of the drive voltage differs from a resonance frequency associated with at least the stretching vibration or bending vibration of the piezoelectric element in a radial direction.

Furthermore, the present invention provides a method for manufacturing an ultrasonic motor. The ultrasonic motor includes a stator which generates a vibration by applying a drive voltage having a predetermined frequency to a piezoelectric element held between a first block and a second block, and a rotor which is pressed on the stator in a slidable manner and rotates due to the vibration of the stator. The manufacturing method comprises a step of providing a fixing portion for fixing the stator to a predetermined support portion on the stator, and a step of forming the fixing portion in such a way that a natural frequency of the fixing portion deviates from a frequency range of the drive voltage where the rotor is rotatable.

Other aspects and advantages of the present invention will be readily apparent from the following description, taken in conjunction with the accompanying drawings, which illustrate by way of example the principles of the invention.

### BRIEF DESCRIPTION OF THE DRAWINGS

The features of the present invention which seem to be novel may be apparent from the appended scope of claims. The present invention, together with objects and advantages thereof, may best be understood by reference to the following description of the presently preferred embodiments together with the accompanying drawings.

FIG. 1 is a perspective view of an ultrasonic motor according to a first embodiment of the present invention;

FIG. 2 is a cross-sectional view of the ultrasonic motor in FIG. 1;

FIG. 3 is a characteristic diagram illustrating the natural frequency of a flange;

FIG. 4 is a characteristic diagram showing the frequency and impedance of the ultrasonic motor in FIG. 1;

FIG. 5 is a characteristic diagram showing a first change value and vibration speed;

FIG. 6 is a characteristic diagram showing a second change value and vibration speed;

FIG. 7 is a perspective view of a stator according to a second embodiment of the present invention;

FIG. 8 is a characteristic diagram showing the natural frequency of the projections in FIG. 7;

FIG. 9 is a cross-sectional view of an ultrasonic motor according to a third embodiment of the present invention;

FIG. 10 is a characteristic diagram showing the frequency and impedance of a stator in FIG. 9;

FIG. 11 is a characteristic diagram showing the frequency and impedance when the shape of the stator is changed;

FIG. 12 is a diagram showing beating when the shape of the stator is changed;

FIG. 13 is a cross-sectional view of an ultrasonic motor according to a fourth embodiment of the present invention;

FIG. 14 is a perspective view of a piezoelectric element according to another example;

FIG. 15 is an explanatory diagram for explaining the bending vibration of the piezoelectric element in FIG. 14;

FIG. 16 is a perspective view of an ultrasonic motor according to the prior art;

FIG. 17 is a characteristic diagram showing the frequency and vibration speed of the ultrasonic motor in FIG. 16;

FIG. 18 is a schematic diagram of the shape of a stator equipped on the ultrasonic motor in FIG. 16 which is specified by FEM analysis;

FIG. 19 is a characteristic diagram showing the frequency and vibration speed of a flange equipped on the ultrasonic motor in FIG. 16; and

FIG. 20 is a schematic diagram of the shape of the flange that is specified by EEM analysis.

### DETAILED DESCRIPTION OF THE PREFERRED EMBODIMENTS

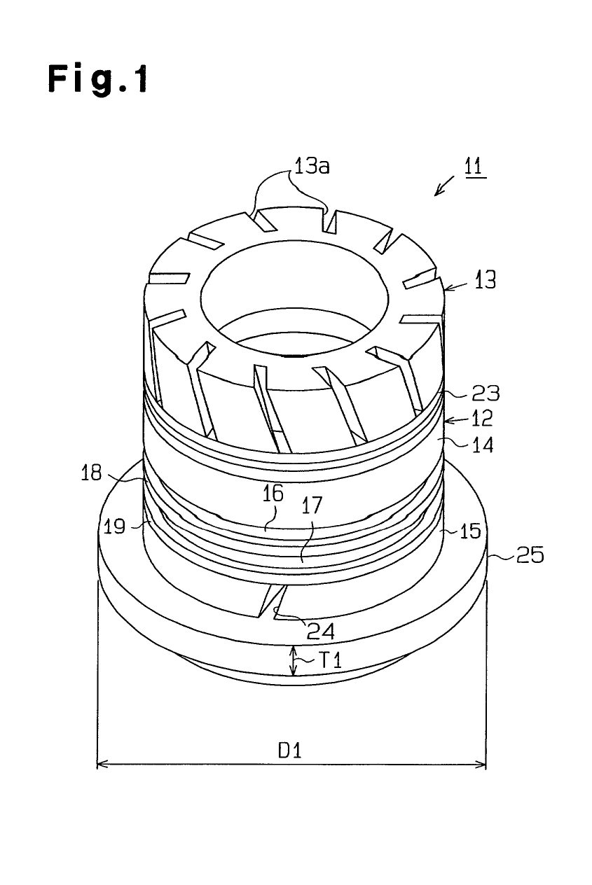

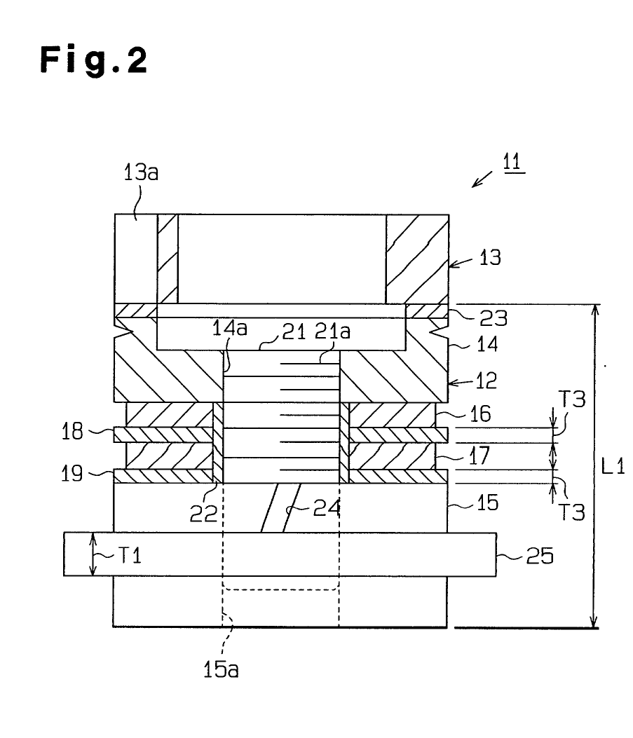

A first embodiment of the present invention will now be described referring to FIGS. 1 to 6. FIGS. 1 and 2 show a perspective view and a cross-sectional view of an ultrasonic motor 11 according to the first embodiment.

A standing-wave type ultrasonic motor 11 has a stator 12 and a rotor 13. The stator 12 includes first and second blocks 14 and 15, first and second piezoelectric elements 16 and 17, first and second electrodes 18 and 19, a bolt 21 as a fastening member, and an insulator collar 22. As a high-frequency voltage is applied between the first and second electrodes 18 and 19, the stator 12 generates a composite vibration to rotate the rotor 13 in one direction.

The first and second blocks 14 and 15, which are made of a conductive metal, are made of an aluminum alloy in this embodiment. A female thread 14a is formed in the inner surface of the first block 14 which has an substantially cylindrical shape. A thin friction member 23 is adhered to the top surface of the first block 14.

The second block 15 is a cylinder the outer diameter of which is about the same as the outer diameter of the first block 14. The internal diameter of the second block 15 is substantially equal to the internal diameter of the first block 14. As indicated by the broken line in FIG. 2, a female thread 15a is formed on the inner surface of the second block 15. A plurality of slits 24 which generate a torsional vibration due to the excited longitudinal vibration are formed on the upper outer surface of the second block 15. Note that only one slit 24 is shown in FIG. 1. Each slit 24 is tilted in the axial direction of the second block 15. A flange 25 as a fixing portion, which extends outward in the radial direction of the second block 15, is provided in the axial center of the second block 15 in such a way as to be positioned below the slits 24.

Through holes are respectively formed in the center portions of the first and second piezoelectric elements 16 and 17 which have disk shapes. The internal diameters of the first and second piezoelectric elements 16 and 17 are larger than the internal diameters of the first and second blocks 14 and 15.

Through holes are formed in the center portions of the first and second electrodes 18 and 19 which are formed in a disk shape. The internal diameters of the first and second electrodes 18 and 19 are equal to the internal diameters of the first and second piezoelectric elements 16 and 17.

The bolt 21 is substantially a cylinder with a male thread 21a formed on the outer surface of the bolt. The bolt 21 is screwed into both female threads 14a and 15a.

The insulator collar 22 is formed of an insulating resin into a cylindrical shape. The outer diameter of the insulator collar 22 is substantially equal to the internal diameters of the first and second piezoelectric elements 16 and 17 and the internal diameters of the first and second electrodes 18 and 19. The internal diameter of the insulator collar 22 is substantially equal to the outer diameter of the male thread 21a of the bolt 21.

The second block 15, the second electrode 19, the second piezoelectric element 17, the first electrode 18, the first piezoelectric element 16 and the first block 14 are laminated in order. As the male thread 21a of the bolt 21, which is to be inserted in the axial direction into those components laminated one on another, is screwed into the female threads 14a and 15a of the first and second blocks 14 and 15, both blocks 14 and 15 are coupled together. The first and second piezoelectric elements 16 and 17 are laminated in such a way that their polarization directions become vertically reverse to each other. The insulator collar 22 is intervened between the inner surfaces of both piezoelectric elements 16 and 17 and both electrodes 18 and 19 and the outer surface of the male thread 21a of the bolt 21. Therefore, the inner surfaces of both piezoelectric elements 16 and 17 and both electrodes 18 and 19 are electrically insulated from the outer surface of the bolt 21. The second electrode 19 is electrically connected to the first block 14 via the second block 15 and the bolt 21.

The rotor 13 is formed into substantially a cylindrical shape the outer diameter of which is equal to the outer diameters of the first and second blocks 14 and 15. The rotor 13 is pressed on the top surface of the stator 12, specifically, on the top surface of the friction member 23 in contact therewith in a slidable and rotatable manner by an unillustrated pressing mechanism. A plurality of slits 13a are formed on the outer surface of the rotor 13 in the circumferential direction of the rotor 13. Each slit 13a is tilted in the axial direction of the rotor 13.

As shown in FIG. 4, the ultrasonic motor 11 constructed in the above-described manner has a frequency F1 (58 kHz in the embodiment) between the first and second electrodes 18 and 19. As a high-frequency voltage is applied, the first and second piezoelectric elements 16 and 17 generate a longitudinal vibration. This frequency F1 is called the “first resonance frequency” of the stator 12. Due to the longitudinal vibration, the individual slits 24 of the stator 12 generate a torsional vibration. At this time, the vibration of the top surface of the stator 12 is a composite vibration where a large torsional vibration and a longitudinal vibration are synthesized. Then, the rotor 13 rotates in the forward direction by the buoyancy originated from the longitudinal vibration component of the stator 12 and the propulsive force originated from the torsional vibration component of the stator 12. This rotational mode is called “stator dominant mode” in the embodiment.

The ultrasonic motor 11 also has a frequency F2 (about 61 kHz in the embodiment) shown in FIG. 4 between the first and second electrodes 18 and 19. As a high-frequency voltage is applied, the first and second piezoelectric elements 16 and 17 generate a longitudinal vibration. This frequency F2 is called the “second resonance frequency F2” of the stator 12. Due to the longitudinal vibration, the individual slits 24 of the stator 12 generate a torsional vibration. At this time, the vibration of the top surface of the stator 12 is a composite vibration where a longitudinal vibration and a small torsional vibration for rotating the rotor 13 in the direction opposite to the rotational direction of the stator dominant mode are synthesized. The resonance frequency of the rotor 13 is so set as to coincide with the second resonance frequency F2. A torsional vibration to rotate the rotor 13 itself in the direction opposite to the rotational direction of the stator dominant mode is generated on the rotor 13 due to the longitudinal vibration of the stator 12. Therefore, the rotor 13 rotates in the reverse direction by the buoyancy originated from the longitudinal vibration component of the stator 12 and the propulsive force originated from the torsional vibration component of the stator 12 and the torsional vibration component of the rotor 13 itself. This rotational mode is called “rotor dominant mode” in the embodiment.

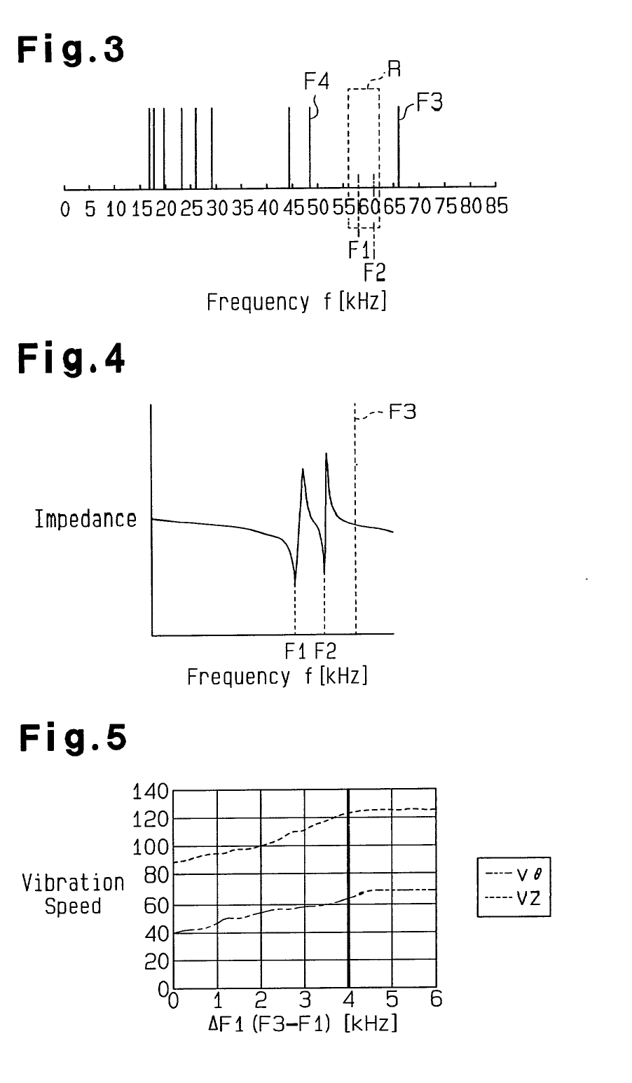

The natural frequency (resonance frequency) of the flange 25 is set apart from the drive frequency range R of the high-frequency voltage for driving the rotor 13 by 3 kHz or greater, as indicated by the solid line extending vertically in FIG. 3.

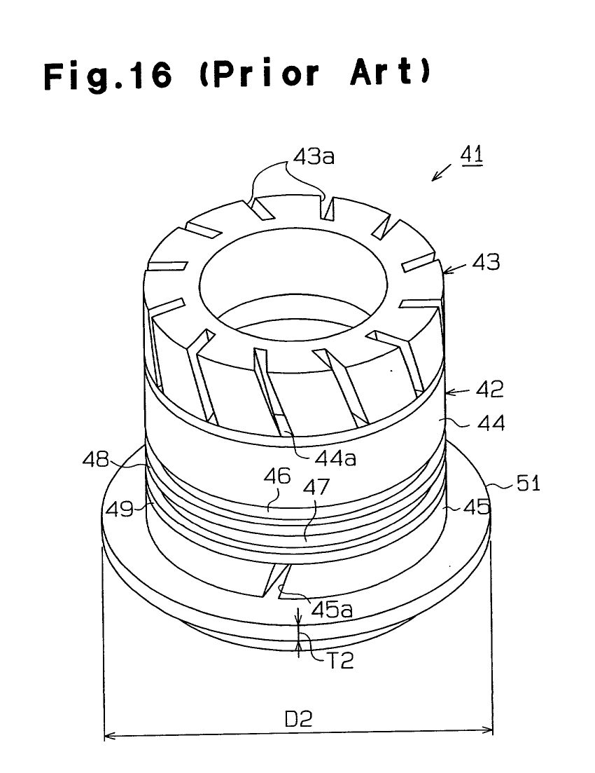

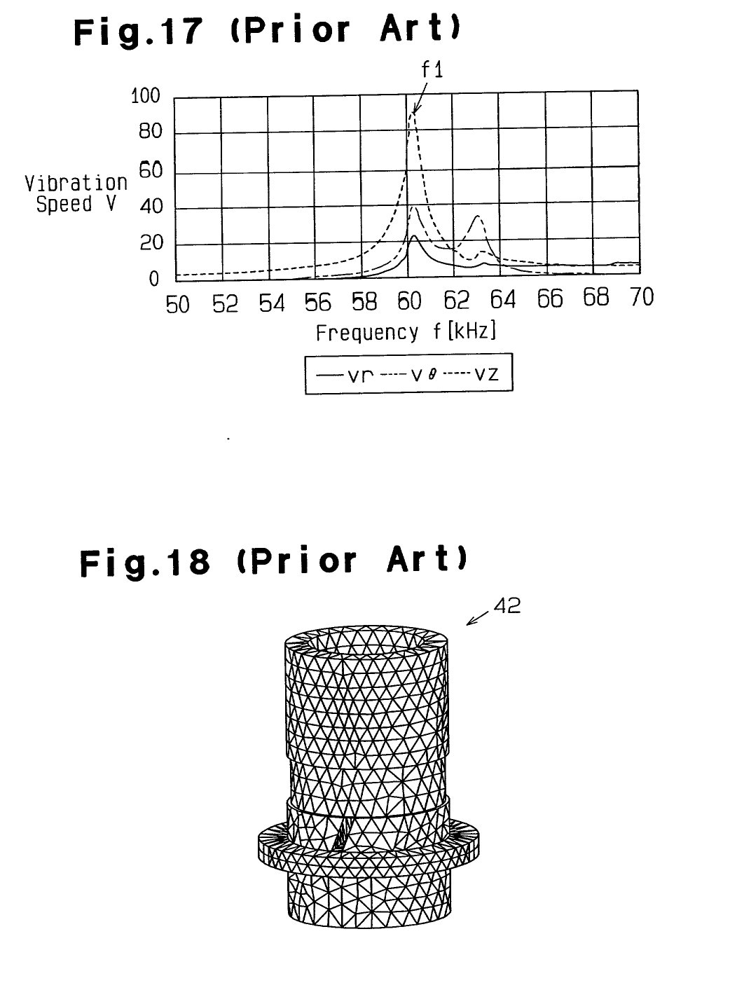

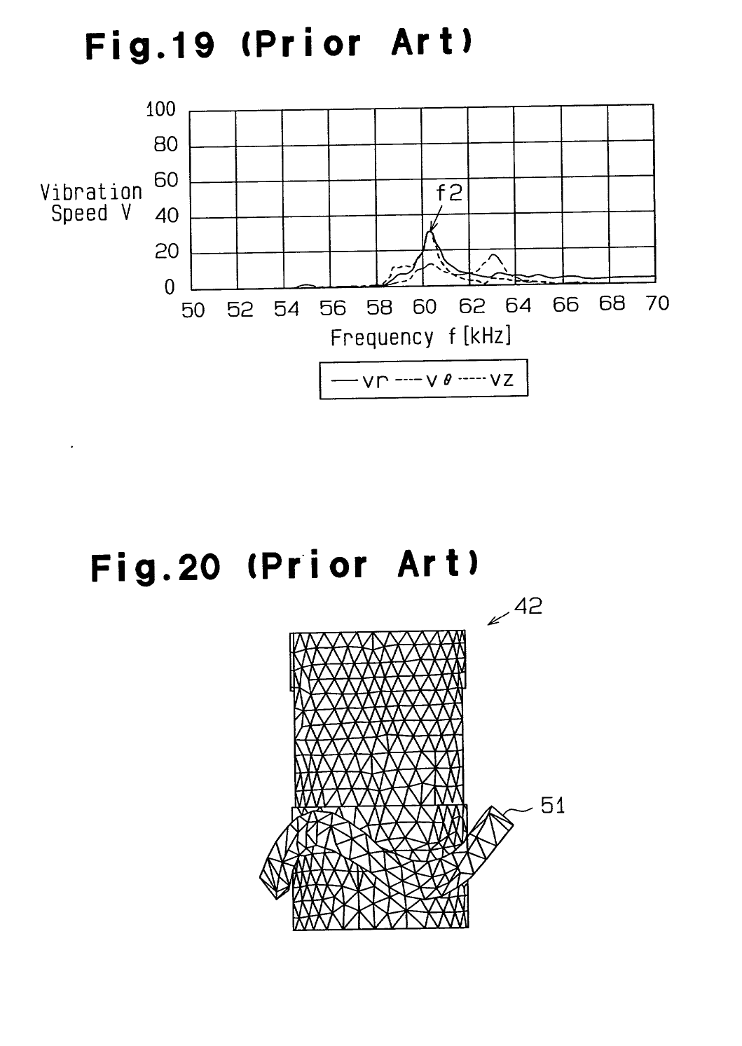

The natural frequency of the flange 25 in the embodiment is set in the aforementioned manner by changing an axial size (thickness) T1 of the flange 25 from the thickness, T2, of the conventional flange 51 with the outer diameter, D1, of the flange 25 set equal to the outer diameter, D2, (see FIG. 16) of the conventional flange 51. In other words, with the outer diameter D1 of the flange 25 set equal to the outer diameter D2 of the conventional flange 51, the thickness T1 of the flange 25 is set in such a way that the flange 25 has a natural frequency characteristic as indicated by the vertical lines in FIG. 3. The thickness T1 of the flange 25 is greater than the thickness T2 of the conventional flange 51. As shown in FIG. 3, the natural frequency of the flange 25 includes a first natural frequency F3 and a second natural frequency F4 which is lower than the first natural frequency F3. The natural frequency of the flange 25 does not exist between the first natural frequency F3 and the second natural frequency F4, and the drive frequency range R lies between the first natural frequency F3 and the second natural frequency F4. The first natural frequency F3 is so set as to be higher than the maximum value in the drive frequency range R by at least 3 kHz, and the second natural frequency F4 is so set as to be lower than the minimum value in the drive frequency range R by at least 3 kHz.

The drive frequency range R includes the first resonance frequency F1 and the second resonance frequency F2. The first and second resonance frequencies F1 and F2 of the stator 12 vary in accordance with the production error of the stator 12 and a change in temperature. An unillustrated control device according to the embodiment supplies a high-frequency voltage having a drive frequency to both electrodes 18 and 19 in accordance with the first and second resonance frequencies F1 and F2 that vary in the mentioned way. The drive frequency range R is the frequency range of the high-frequency voltage where the rotor 13 can be rotated efficiently in the forward and reverse directions. In the embodiment, the drive frequency range R is set to about 56 kHz to about 62 kHz.

The following will discuss the first and second natural frequencies F3 and F4 of the flange 25. FIG. 5 shows the relationship between a first frequency difference ΔF1 (F3−F1) and the vibration speed v of the top surface of the stator 12. The first frequency difference ΔF1 is a difference between the first natural frequency F3 and the first resonance frequency F1. The first natural frequency F3 is altered by changing the thickness T1 of the flange 25 as mentioned earlier.

As shown in FIG. 5, until the first frequency difference ΔF1 increases to 4 kHz from 0 kHz, the values of the torsional vibration speed vθ and the longitudinal vibration speed vz, when the high-frequency voltage is applied, increase gradually. Even when the first frequency difference ΔF1 further increases from 4 kHz, the values of the torsional vibration speed vθ and the longitudinal vibration speed vz, when the high-frequency voltage is applied, are substantially constant. FIG. 5 shows that when the first frequency difference ΔF1 is smaller than 4 kHz, the torsional vibration speed vθ and the longitudinal vibration speed vz are influenced by the flange 25 and become smaller.

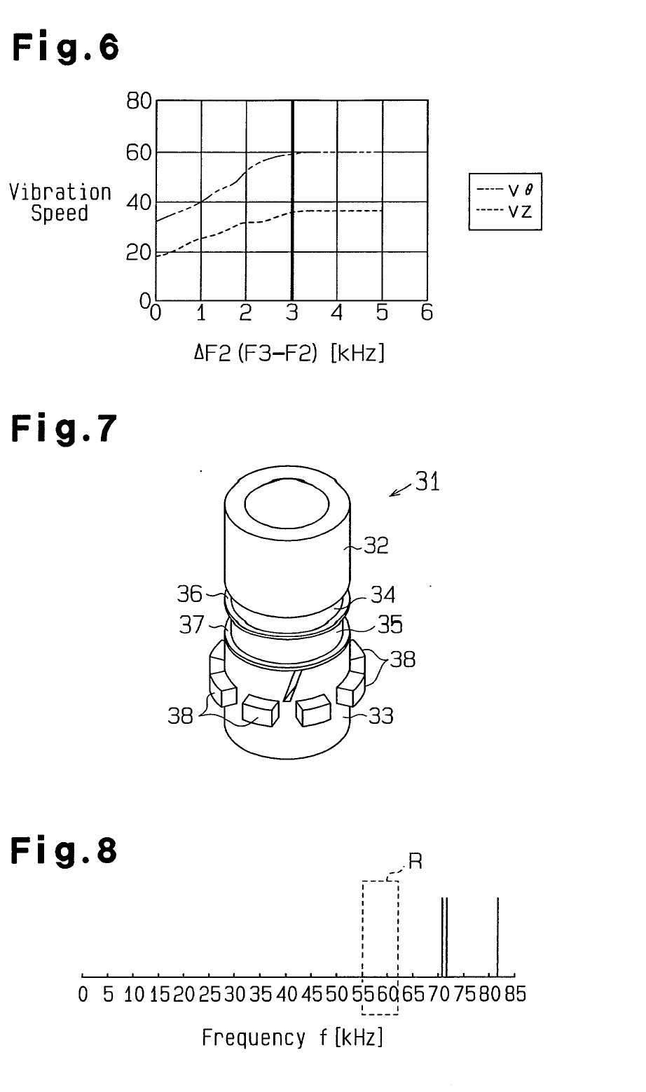

FIG. 6 shows the relationship between a second frequency difference ΔF2 (F3−F2) and the vibration speed v of the top surface of the stator 12. The second frequency difference ΔF2 is a difference between the first natural frequency F3 and the second resonance frequency F2. As shown in FIG. 6, until the second frequency difference ΔF2 increases to 3 kHz from 0 kHz, the values of the torsional vibration speed vθ and the longitudinal vibration speed vz, when the high-frequency voltage is applied, increase gradually. Even when the second frequency difference ΔF2 further becomes greater than 3 kHz, the values of the torsional vibration speed vθ and the longitudinal vibration speed vz, when the high-frequency voltage is applied, are substantially constant. FIG. 6 shows that when the second frequency difference ΔF2 is smaller than 3 kHz, the torsional vibration speed vθ and the longitudinal vibration speed vz are influenced by the flange 25 and become smaller.

The relationship between a third frequency difference ΔF3 (F1−F4) and the vibration speed v of the stator 12 (the top surface of the stator block 14), which is not illustrated, shows a characteristic similar to that shown in FIG. 6 according to the results of measurements. The third frequency difference ΔF3 is a difference between the first resonance frequency F1 and the second natural frequency F4. The second natural frequency F4 is altered by changing the thickness T1 of the flange 25 as mentioned earlier. Until the third frequency difference ΔF3 increases to 3 kHz from 0 kHz, the values of the torsional vibration speed vθ and the longitudinal vibration speed vz, when the high-frequency voltage is applied, increase gradually. Even when the third frequency difference ΔF3 further becomes greater than 3 kHz, the values of the torsional vibration speed vθ and the longitudinal vibration speed vz become substantially constant. When the third frequency difference ΔF3 is smaller than 3 kHz, the torsional vibration speed vθ and the longitudinal vibration speed vz are influenced by the flange 25 and become smaller.

The relationship between a fourth frequency difference ΔF4 (F2−F4) and the vibration speed v of the stator 12 (the top surface of the stator block 14), which is not illustrated, shows a characteristic similar to that shown in FIG. 6 according to the results of measurements. The fourth frequency difference ΔF4 is a difference between the second resonance frequency F2 and the second natural frequency F4. Until the fourth frequency difference ΔF4 increases to 4 kHz from 0 kHz, the values of the torsional vibration speed vθ and the longitudinal vibration speed vz, when the high-frequency voltage is applied, increase gradually. Even when the fourth frequency difference ΔF4 further becomes greater than 4 kHz, the values of the torsional vibration speed vθ and the longitudinal vibration speed vz become substantially constant. When the fourth frequency difference ΔF4 is smaller than 4 kHz, the torsional vibration speed vθ and the longitudinal vibration speed vz are influenced by the flange 25 and become smaller.

The second resonance frequency F2 is set higher than the first resonance frequency F1 by at least 1 kHz. If the first natural frequency F3 is higher than the second resonance frequency F2 by at least 3 kHz, therefore, the values of the torsional vibration speed vθ and the longitudinal vibration speed vz are not easily influenced by the flange 25 when the high-frequency voltage is applied, and become stable at large values. As the first resonance frequency F1 is set lower than the second resonance frequency F2 by at least 1 kHz, the values of the torsional vibration speed vθ and the longitudinal vibration speed vz are not easily influenced by the flange 25 when the high-frequency voltage is applied, if the second natural frequency F4 is lower than the first resonance frequency F1 by at least 3 kHz, so that the torsional vibration speed vθ and the longitudinal vibration speed vz become stable at large values. In view of the above, it is desirable that the natural frequency of the flange 25 be set to a value apart from the drive frequency range R by 3 kHz.

In the ultrasonic motor 11 the flange 25 of which has its natural frequency set in the aforementioned way, the flange 25 hardly influences the vibration of the stator 12, so that the rotation of the rotor 13 becomes stable.

The embodiment has the following advantages.

The natural frequency of the flange 25 is easily changed by changing the axial thickness T1 of the flange 25. Setting the natural frequency of the flange 25 off the drive frequency range R can prevent the vibration of the flange 25 from affecting the rotation of the rotor 13. Particularly, excellent motor characteristics can be demonstrated by setting the natural frequency of the flange 25 apart from the drive frequency range R by at least 3 kHz. That is, the energy of the vibration of the stator 12 is efficiently converted to the energy of the rotation of the rotor 13 and the generation of noise due to the vibration of the flange 25 is suppressed. The improved energy conversion efficiency can allow the ultrasonic motor 11, even in a small size, to generate large drive force.

The thickness T1 of the flange 25 is made greater than the thickness T2 of the conventional flange 51 in FIG. 16 and the first natural frequency F3 is set higher than the drive frequency range R by at least 3 kHz. It is therefore possible to prevent the vibration of the flange 25 from affecting the rotation of the rotor 13 without sacrificing the strength of the flange 25.

The natural frequency of the flange 25 is set by changing the axial thickness T1 of the flange 25 from the thickness T2 of the conventional flange 51 shown in FIG. 16. It is therefore possible to set the natural frequency of the flange 25 by a slight modification of the prior art.

A second embodiment of the present invention will now be described referring to FIGS. 7 and 8. In the embodiment, a stator 31 the shape of which is different from the shape of the stator 12 in the embodiment in FIGS. 1 to 6 is used. A detailed description of those components which are similar or identical to the corresponding components of the embodiment in FIGS. 1 to 6 will be omitted.

As shown in FIG. 7, the stator 31 has first and second blocks 32 and 33, first and second piezoelectric elements 34 and 35, first and second electrode plates 36 and 37, and an unillustrated bolt. In place of the flange 25 in the embodiment in FIGS. 1 to 6, a plurality of projections 38 as a fixing portion are provided at equiangular distances about the axis of the stator 31. Each projection 38 has substantially a rectangular parallelepiped shape which is curved along the outer surface of the second block 33.

As shown in FIG. 8, the projections 38 have a natural frequency as indicated by the vertical lines in FIG. 5 with respect to the frequency f of a high-frequency voltage which is applied to the first and second piezoelectric elements 34 and 35. Specifically, the natural frequency of the projections 38 is set higher than the maximum value in the drive frequency range R of the high-frequency voltage to drive the rotor by at least 3 kHz. The drive frequency range R is indicated by the broken line in FIG. 8. The natural frequency of the projections 38 is greater than the maximum value in the drive frequency range R. That is, the vibration of the projections 38 does not influence the vibration of the stator 31. The rotor can therefore be rotated very efficiently.

The embodiment has the following advantages.

The natural frequency of each projection 38 is so set as to be higher than the maximum value in the drive frequency range R by at least 3 kHz, as indicated by the solid lines (vertical lines) in FIG. 8. As in the embodiment in FIGS. 1 to 6, therefore, the projections 38 hardly influence the vibration of the stator 31, and thus hardly influence the rotation of the rotor. As a result, the high-frequency voltage is converted to the energy for the rotation of the rotor more efficiently and the generation of noise originated from the vibration of the projections 38 is suppressed, as compared with the prior art. The improved energy conversion efficiency can allow the ultrasonic motor, even in a small size, to generate large drive force.

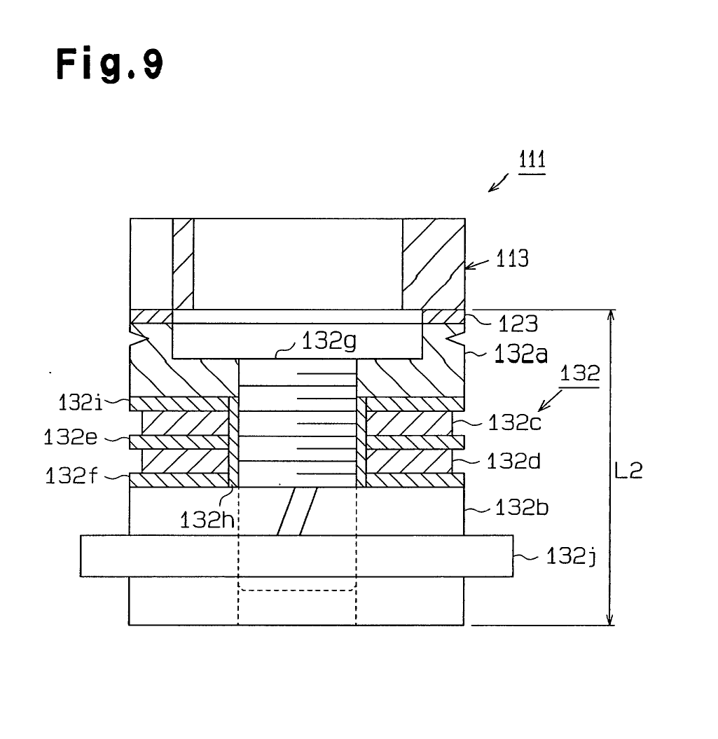

A third embodiment of the present invention will now be described referring to FIGS. 9 to 12. An ultrasonic motor 111 of the embodiment uses a stator 132 which is different from the stator 12 in the embodiment in FIGS. 1 to 6. A detailed description of those components which are similar or identical to the corresponding components of the embodiment in FIGS. 1 to 6 will be omitted.

As shown in FIG. 9, the standing-wave type ultrasonic motor 111 has a stator 132 and a rotor 13. The stator 132 includes first and second blocks 132a and 132b, first and second piezoelectric elements 132c and 132d, first, second and third electrodes 132e, 132f and 132i, a bolt 132g as a fastening member, and an insulator collar 132h. The first to third electrodes 132e, 132f and 132i are all identical in shape. The ultrasonic motor 111 of the embodiment is equivalent to the ultrasonic motor 11 shown in FIGS. 1 and 2 to which the third electrode 132i is added.

The third electrode 132i is located between the first block 132a and the first piezoelectric element 132c. The insulator collar 132h is intervened between the inner surface of the third electrode 132i and the outer surface of the bolt 132g. The inner surface of the third electrode 132i is therefore electrically insulated from the outer surface of the bolt 132g.

The second block 132b is provided with a flange 132j. The natural frequency f the flange 132j is designed not to overlap the drive frequency range R of the high-frequency voltage that can drive the ultrasonic motor 111.

The diametrical size of the stator 132 is substantially equal to that of the stator 12 in FIG. 2. The axial size L2 of the stator 132 is 1.15 times the axial size of the stator 12 in case where the third electrode plate identical in shape to the first and second electrodes 18 and 19 is added to the stator 12 in FIG. 2. That is, given that the axial size of the stator 12 is L1 and the axial thickness of each electrode plate 18 or 19 is T3 in FIG. 2, the axial size, L2, of the stator 132 in the embodiment becomes 1.15 times (L1+T3).

The axial size of the bolt 132g is changed in accordance with the axial size of the first block 132a. The axial sizes of those components, excluding the first block 132a, which constitute the stator 132, namely, the second block 132b, the first and second piezoelectric elements 132c and 132d and the first, second and third electrodes 132e, 132f and 132i, are substantially equal to the axial sizes of the corresponding components of the stator 12 in FIG. 2.

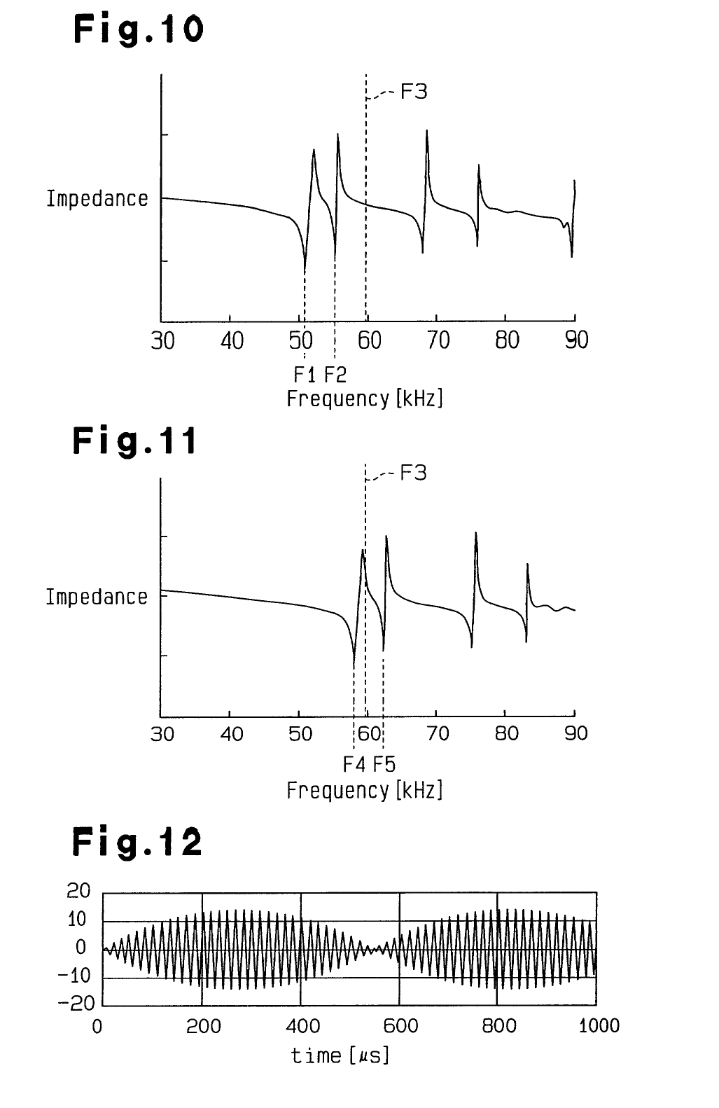

It is found through FEM analysis that the stator 132 in the embodiment has a resonance frequency characteristic as indicated by the solid line in FIG. 10. When a high-frequency voltage having a first frequency F1 as a drivable frequency shown in FIG. 10 is applied to the first, second and third electrodes 132e, 132f and 132i, composite vibration is generated on the top surface of the stator 132, causing the rotor 13 to rotate clockwise. When a high-frequency voltage having a second frequency F2 as a drivable frequency is applied to the first, second and third electrodes 132e, 132f and 132i, the rotor 13 is rotated counterclockwise.

It has been checked through experiments that with regard to the stretching vibration in the radial direction, the first and second piezoelectric elements 132c and 132d have a resonance frequency F3 of 59.5 kHz as indicated by a broken line in FIG. 10. The radial stretching vibration of the first and second piezoelectric elements 132c and 132d, unlike the longitudinal vibration for driving the rotor 13, produces a loss in the vibration of the stator 132 and is thus unnecessary to drive the rotor 13.

The difference between each frequency F1, F2 and the resonance frequency F3 (59.5 kHz) is large, so that when the stator 132 vibrates to rotate the rotor 13, the first and second piezoelectric elements 132c and 132d do not resonate in the radial direction. Therefore, a loss does not occur in the vibration of the stator 132, allowing the rotor 13 to rotate efficiently.

It is checked through FEM analysis that the stator 132 with the axial size L2 being L1+T3 has a resonance frequency characteristic as indicated by the solid line in FIG. 11. When a high-frequency voltage having a third frequency F4 as a drivable frequency shown in FIG. 11 is applied to the stator 132, the rotor 13 rotates clockwise, whereas when a high-frequency voltage having a fourth frequency F5 as a drivable frequency is applied to the stator 132, the rotor 13 rotates counterclockwise.

As shown in FIG. 11, there is a slight difference between each frequency F4, F5 and the resonance frequency F3. Specifically, as the third frequency F4 is 57.3 kHz and the fourth frequency F5 is 61.3 kHz, the differences between the frequencies F4 and F5 and the resonance frequency F3 are 2.2 kHz and 1.8 kHz, respectively. If the frequency difference is small, stretching vibration occurs on the piezoelectric elements 132c and 132d in the radial direction at the time the rotor 13 is driven, thus producing a loss in the vibration of the stator 132.

FIG. 12 shows a change in beating which occurs in the motor as the vibration of the fourth frequency F5 is added to the vibration of the resonance frequency F3 of both piezoelectric elements 132c and 132d. If the third and fourth frequencies F4 and F5 and the resonance frequency F3 have slight differences, beating occurs in the stator, generating noise.

The axial size L2 of the stator 132 in the embodiment is however 1.15 times (L1+T3). This makes it possible to rotate the rotor 13 efficient without causing unnecessary vibration or beating. The resonance frequency characteristic of the stator 132 can easily be altered by changing the axial size L2 of the stator 132. This can ensure easy prevention of a loss in the vibration of the stator 132 and the generation of noise.

The embodiment has the following advantages.

The axial size L2 of the stator 132 is set in such a way that the resonance frequencies F1 and F2 of the stator 132, i.e., the frequencies F1 and F2 of the high-frequency voltage for rotating the rotor 13, do not coincide with the resonance frequency F3 which is associated with radial stretching vibration of the first and second piezoelectric elements 132c and 132d. At the time the ultrasonic motor 111 is driven, therefore, the first and second piezoelectric elements 132c and 132d do not resonate in the radial direction, causing no loss in the vibration of the stator 132. This leads to an improvement in the efficiency of driving the ultrasonic motor 111.

The axial size L2 of the stator 132 is set in such a way that the difference between the frequency F1, F2 and the resonance frequency F3 becomes large enough not to cause beating in the motor. It is therefore possible to suppress the generation of beating due to the vibration of the first and second piezoelectric elements 132c and 132d at the time the ultrasonic motor 111 is driven.

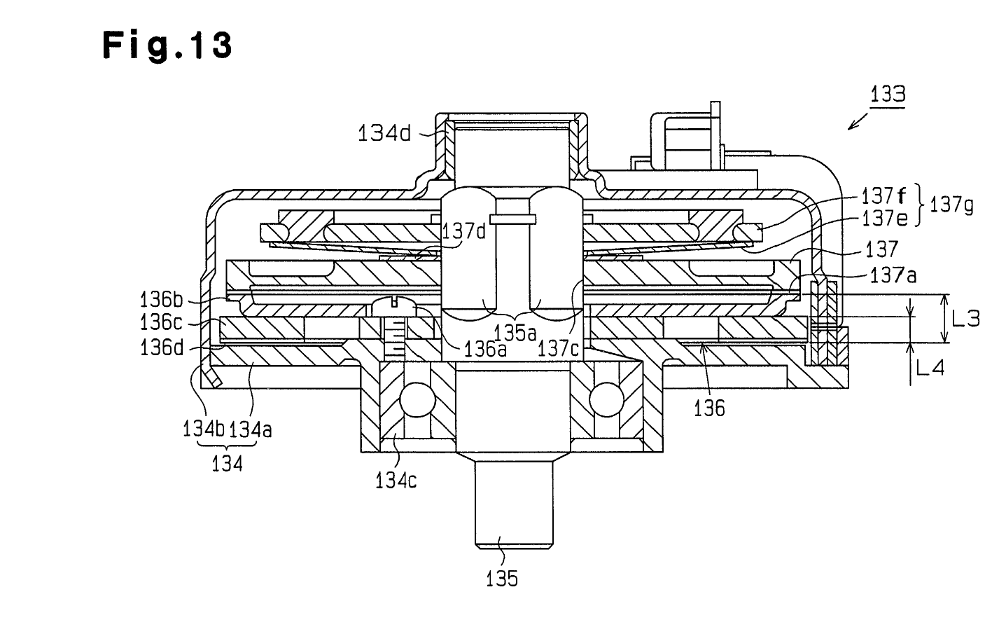

A fourth embodiment of the present invention will now be described referring to FIG. 13. FIG. 13 shows a cross-sectional view of a traveling-wave type ultrasonic motor 133. The ultrasonic motor 133 has a housing 134. The housing 134 has a base 134a and a cover 134b. A rotary shaft 135 is rotatably supported by bearings 134c and 134d respectively provided on the base 134a and cover 134b. A fitting portion 135a which has four flat portions is formed on the rotary shaft 135.

A stator 136 which has substantially a disk shape is fastened onto the base 134a by a screw 136a. The stator 136 has a vibration transmission portion 136b which transmits vibration to a rotor 137 to be discussed later. A base ring 136c is provided on the lower portion of the vibration transmission portion 136b. A piezoelectric element 36d is connected to the bottom surface of the base ring 136c.

The rotor 137 which has substantially a disk shape is provided on the top surface of the stator 136. The rotor 137 has a lining member 137a which abuts on the vibration transmission portion 136b. Formed in the center portion of the rotor 137 is an insertion hole 137c in which the fitting portion 135a is to be inserted. The rotor 137 is coupled to the rotary shaft 135 in such a way as to be movable in the axial direction and not to be rotatable relatively. The rotor 137 and the rotary shaft 135 rotate integrally.

A disk portion 137d which has substantially a disk shape is provided on the top surface of the rotor 137. The disk portion 137d is coupled to the rotary shaft 135 in such a way as to be movable in the axial direction and not to be rotatable relatively. The top surface of the disk portion 137d is pressed by an urging member 137g, which comprises a belleville spring 137e having substantially a truncated-cone shape and a disk-shaped plate 137f. The rotor 137 is pressed against the stator 136 by predetermined force.

As a high-frequency drive voltage is applied to the piezoelectric element 136d of the ultrasonic motor 133, the piezoelectric element 136d vibrates. The vibration of the piezoelectric element 136d becomes traveling-wave vibration in the vibration transmission portion 136b of the stator 136 via the base ring 136c. Due to the traveling-wave vibration, the rotor 137 rotates, causing the rotary shaft 135 to rotate.

The resonance frequency characteristic of the stator 136 of the ultrasonic motor 133 with the above-described structure can easily altered by changing the axial size, L3, of the stator 136, as in the case of the stator 132 in FIG. 9.

The resonance of the piezoelectric element 136d in the radial direction causes a loss in the vibration of the stator 136 and beating in the embodiment too.

In the embodiment, as per the embodiment in FIG. 9, the resonance frequency of the stator 136, i.e., the difference between the frequency of the high-frequency voltage for rotating the rotor 137 and the radial resonance frequency of the piezoelectric element 136d, is so set as to become larger by adjusting the axial size L3 of the stator 136.

The axial size L3 of the stator 136 is adjusted by changing the axial size, L4, of the base ring 136c of the stator 136 in the embodiment. Only the axial size of the base ring 136c, not the axial sizes of the vibration transmission portion 136b and the piezoelectric element 136d which also constitute the stator 136, is changed.

As a result, no loss occurs in the vibration of the stator 32, permitting the rotor 137 to rotate efficiently and preventing the beating-originated generation of noise.

The embodiment has the following advantages.

The axial size L3 of the stator 136 is set in such a way that the frequency of the high-frequency voltage for rotating the rotor 137 does not coincide with the resonance frequency that is associated with radial stretching vibration of the piezoelectric element 136d. At the time the ultrasonic motor 133 is driven, therefore, the piezoelectric element 136d does not resonate in the radial direction, causing no loss in the vibration of the stator 136. This improves the efficiency of driving the ultrasonic motor 133.

The axial size L3 of the stator 32 is set in such a way that the difference between the frequency of the high-frequency voltage and the resonance frequency which is associated with the radial stretching vibration of the piezoelectric element 136d becomes large enough not to cause beating in the motor. It is therefore possible to suppress the generation of beating due to the vibration of the piezoelectric element 136d at the time the ultrasonic motor 133 is driven.

The above-described embodiments may be modified as follows.

In the embodiment in FIGS. 1 to 6, the shape of the flange 25 is not restrictive if the flange 25 has a natural frequency different from the drive frequency range R of the high-frequency voltage that is applied to the ultrasonic motor 11. For example, the flange 25 may be formed with a bolt hole or groove or may be chamfered, or the periphery of the flange 25 may have a polygonal shape instead of a circle. In the embodiment in FIGS. 7 and 8, likewise, the shape of the stator 31 is not restrictive if the stator 31 has a natural frequency higher than the drive frequency range R of the high-frequency voltage. For example, the projections 38 may be formed with bolt holes or grooves or may be chamfered.

In the embodiment in FIGS. 1 to 6, the thickness T1 of the flange 25 may be made smaller than the thickness T2 of the conventional flange 51. Further, the natural frequency of the flange 25 may be changed to prevent the vibration of the flange 25 from affecting the rotation of the rotor 13 by setting the outer diameter Dl of the flange 25 smaller or larger than the outer diameter D2 of the conventional flange 5.

In each of the embodiments in FIGS. 1 to 12, the ultrasonic motor may be modified to an ultrasonic motor which has three or more blocks.

In each of the embodiments in FIGS. 1 to 12, the fastening member that fastens the stator 12, 31 or 132 is not limited to the bolt 21 or 132g, but may be changed to another member (such as one which fastens the stator by crimping).

In the stator 12, 31 or 132 in each of the embodiments in FIGS. 1 to 12, the number of the piezoelectric elements may be changed as needed as long as at least one piezoelectric element is provided.

In the stator 12, 31 or 132 in each of the embodiments in FIGS. 1 to 12, the number of the electrode plates may be changed as needed. No electrode plate may be provided (as in the case where the blocks themselves serve as electrode plates) or three or more electrode plates may be provided.

In the embodiment in FIGS. 7 and 8, the projections 38 should not necessarily be provided at equiangular distances about the axis of the second block 15.

Although the axial size L2 of the stator 132 is set to be 1.15 times (L1+T3) in the embodiment in FIG. 9, it may take other magnifications if the stator 132 has the resonance frequencies F1 and F2 that have large differences from the resonance frequency F3 of the first and second piezoelectric elements 132c and 132d.

In the embodiment in FIG. 9, the axial size of only the second block 132b may be adjusted or the axial sizes of only the first and second piezoelectric elements 132c and 132d may be adjusted. The axial sizes of only the first, second and third electrodes 132e, 132f and 132i may be adjusted. Alternatively, the axial sizes of all of the first block 132a, the second block 132b, the first and second piezoelectric elements 132c and 132d and the first, second and third electrodes 132e, 132f and 132i may be adjusted. That is, the axial size of at least one arbitrarily selected from a plurality of members that constitute the stator has only to be adjusted. In the embodiment in FIG. 13, likewise, the axial size of at least one arbitrarily selected from a plurality of members that constitute the stator 136, namely, the vibration transmission portion 136b, the piezoelectric element 136d and the base ring 136c, has only to be adjusted.

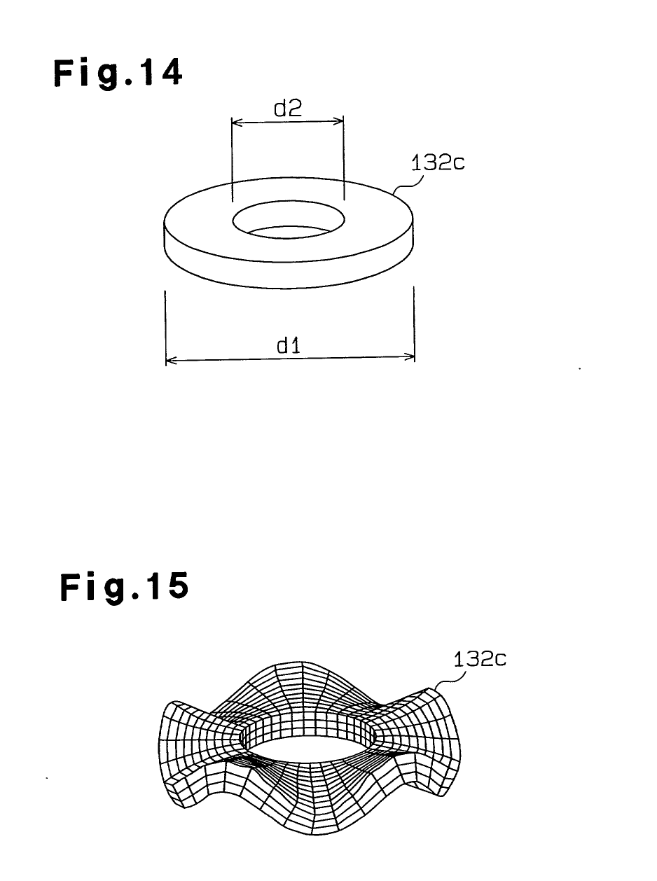

The differences between the first and second resonance frequencies F1 and F2 and the resonance frequency F3 may be made larger by changing the resonance frequency F3 by adjusting a mean diameter r which is acquired from the outer diameter d1, and the internal diameter d2, of the first piezoelectric element 132c in FIG. 9 as apparent from FIG. 14. The mean diameter r is obtained as follows.

r=(d1+d2)/2

Although FIG. 14 shows only the first piezoelectric element 132c in FIG. 9, the second piezoelectric element 132d has the same shape as the first piezoelectric element 132c so that the resonance frequency F3 can be changed in a similar way. In the embodiment in FIG. 13, likewise, the difference between the frequency of the stator 136 and the resonance frequency of the piezoelectric element 136d may be made larger by changing the radial resonance frequency of the piezoelectric element 136d by adjusting the mean diameter that is acquired from the outer diameter and the internal diameter of the piezoelectric element 136d.

In the embodiment in FIGS. 9 to 12, the differences between the resonance frequency associated with bending vibration of the first and second piezoelectric elements 132c and 132d and the first and second frequencies F1 and F2 of the stator 132 may be set larger similarly with the shape of the first piezoelectric element 132c shown in FIG. 15 that is specified by FEM analysis. This modification can suppress resonance in the bending direction as well as radial resonance of the first and second piezoelectric elements 32c and 32d, resulting in a further improvement in the rotational efficiency of the rotor 13 and further prevention of the beating-originated generation of noise. In the embodiment in FIG. 13, likewise, the difference between the resonance frequency associated with bending vibration of the piezoelectric element 136d and the frequency of the stator 136 may be set larger.

In the embodiment in FIG. 13, the combination of the components that adjusts the axial size may be only the base ring 136c and the vibration transmission portion 136b, only the base ring 136c and the piezoelectric element 136d or only the vibration transmission portion 136b and the piezoelectric element 136d.

The present invention may be embodied into an ultrasonic motor the rotor of which is rotated only in one direction. Further, the present invention may be embodied into ultrasonic motors that utilize vibration which is generated by applying a voltage to a piezoelectric element, such as a linear ultrasonic actuator and a cylindrical ultrasonic motor which uses a bending vibration.

1. An ultrasonic motor comprising:
a stator, wherein the stator includes:
a first block;
a second block; and
a piezoelectric element, which is held between said first and second blocks and vibrates when receiving a drive voltage having a predetermined frequency, so that said stator produces resonance vibration in accordance with vibration of said piezoelectric element;
a rotor which is pressed on said stator in a slidable manner and rotates due to vibration of said stator; and
a fixing portion provided on said stator to fix said stator to a predetermined support portion and formed in such a way that a natural frequency of said fixing portion deviates from a frequency range of said drive voltage where said rotor is rotatable.

2. The ultrasonic motor according to claim 1, wherein said fixing portion is formed in such a way that said natural frequency of said fixing portion does not exist in said frequency range.

3. The ultrasonic motor according to claim 1, wherein said natural frequency of said fixing portion is determined by a size or a shape of said fixing portion.

4. The ultrasonic motor according to claim 1, wherein said fixing portion is a flange provided around said stator.

5. The ultrasonic motor according to claim 4, wherein said natural frequency of said flange is determined by an axial size or a diametrical size of said flange.

6. The ultrasonic motor according to claim 1, wherein said fixing portion is a plurality of projections provided around said stator.

7. The ultrasonic motor according to claim 1, wherein said natural frequency of said fixing portion is set apart from said frequency range by 3 kHz or greater.

8. The ultrasonic motor according to claim 1, wherein said natural frequency of said fixing portion is higher than the maximum value in said frequency range.

9. The ultrasonic motor according to claim 8, wherein said natural frequency of said fixing portion is set apart from said frequency range by 3 kHz or greater.

10. The ultrasonic motor according to claim 8, wherein said fixing portion is a plurality of projections provided around said stator.

11. The ultrasonic motor according to claim 1, wherein a first frequency which is a frequency of said drive voltage to rotate said rotor in one direction and a second frequency which is a frequency of said drive voltage to rotate said rotor in the other direction exist in said frequency range.

12. An ultrasonic motor comprising:
a stator having a piezoelectric element which vibrates when receiving a drive voltage having a predetermined frequency, so that said stator produces resonance vibration in accordance with vibration of said piezoelectric element; and
a rotor that is pressed on said stator in a slidable manner and rotates due to the vibration of said stator, which is formed in such a way that a frequency of said drive voltage differs from a resonance frequency associated with at least stretching vibration or bending vibration of said piezoelectric element in an axial direction.

13. The ultrasonic motor according to claim 12, wherein a difference between said frequency of said drive voltage and said resonance frequency of said piezoelectric element is large enough not to cause beating in said ultrasonic motor.

14. The ultrasonic motor according to claim 12, wherein said resonance frequency of said piezoelectric element is determined by an axial size of said stator.

15. The ultrasonic motor according to claim 12, wherein said piezoelectric element has a ring shape and said resonance frequency of said piezoelectric element is determined by an internal diameter or an outer diameter of said piezoelectric element.

16. The ultrasonic motor according to claim 12, wherein said ultrasonic motor is of a standing-wave type or a traveling-wave type.

17. A method for manufacturing an ultrasonic motor including a stator which generates vibration by applying a drive voltage having a predetermined frequency to a piezoelectric element held between a first block and a second block, and a rotor which is pressed on said stator in a slidable manner and rotates due to the vibration of said stator, said method comprising:
a step of providing a fixing portion on said stator for fixing said stator to a predetermined support portion; and
a step of forming said fixing portion in such a way that a natural frequency of said fixing portion comes off a frequency range of said drive voltage where said rotor is rotatable.

18. The method according to claim 17, further including a step of determining said natural frequency of said fixing portion by a size or a shape of said fixing portion.

19. The method according to claim 17, wherein said fixing portion is a flange provided around said stator and said method further includes a step of determining said natural frequency of said flange by an axial size or a diametrical size of said flange.
